(19) United States
(12) Patent Application Publication
(10) Pub. No.: US 2015/0345208 A1
(43) Pub. Date: Dec. 3, 2015

(54) WINDOW PANE HAVING A PERIPHERAL SEAL, AND CORRESPONDING MANUFACTURING METHOD

(71) Applicant: AGC GLASS EUROPE, Louvain-La-Neuve (BE)

(72) Inventors: Pierre BOULANGER, Couthuin (BE); Priscille DREUX, Saint Saulve (FR); Fabien MONTEVERDE, Boussois (FR); Fabian RENAUX, Villers Saint Ghislain (Mons) (BE)

(73) Assignee: AGC GLASS EUROPE, Louvain-La-Neuve (BE)

(21) Appl. No.: 14/760,330

(22) PCT Filed: Dec. 16, 2013
(86) PCT No.: PCT/EP13/76663

§ 371 Date: Jul. 10, 2015

(30) Foreign Application Priority Data
Jan. 11, 2013 (BE) BE 2013/0018

(51) Int. Cl. E06B 3/673; E06B 3/66; E06B 3/67; E06B 3/663

(52) U.S. Cl. CPC E06B 3/67391; E06B 3/66304; E06B 3/6612; E06B 3/67; E06B 3/673

(57) ABSTRACT

The invention relates to a peripheral seal for a window pane, particularly an insulating window pane, including at least a first (5) and a second (5) glass sheet that are combined together via at least one spacer (8) that keeps same at a certain distance from one another, and between said at least two glass sheets (5), at least one inner space (4) is closed by the peripheral seal (1, 101, 102) arranged on the periphery of the glass sheets, around said inner space (4). According to the invention, the cross-section of the seal (1, 101, 102) includes a median portion and first (1011, 1021) and second (1012, 1022) end portions respectively secured to the first and second glass sheets (5). According to the invention, the cross-section of the seal (1, 101, 102) forms at least one cavity (1013, 1023) facing at least one of the side surfaces (52) of the first and second glass sheets (5).

### 1. FIELD OF THE INVENTION

The field of the invention is that of glazing panels comprising glass sheets bounding internal spaces, also referred to as multiple glazing panels.

The invention more particularly relates to the peripheral seals of these multiple glazing panels.

These panels may be used in any type of application such as in general-purpose glazing units, automotive glazing units or architectural glazing units.

### 2. SOLUTIONS OF THE PRIOR ART

One type of glazing panel to which the invention relates is for example the type of glazing panel referred to as an insulating glass unit.

Such an insulating glazing panel conventionally comprises first and second glass sheets associated together by way of at least one spacer or insert that holds them parallel at a certain distance from each other. The panel is sealed on its periphery by virtue of a peripheral seal so that the space between the glass sheets, also called the internal space, is completely closed.

The internal space may enclose a gas, for example, but not exclusively, dry air, argon (Ar), krypton (Kr), xenon (Xe), sulfur hexafluoride (SF₆) or even a mixture of certain of these gases. The transfer of energy through an insulating panel having this conventional structure is decreased, because of the presence of the gas in the internal space, relative to a single glass sheet.

The internal space may also be pumped of any gas, a vacuum glazing unit then being spoken of. Energy transfer through a vacuum-insulated insulating glazing panel is greatly decreased by the vacuum.

A vacuum-insulated glazing panel is typically composed of at least two glass sheets separated by a space in which a vacuum has been generated. Such a glazing unit is conventionally used for its high thermal insulation properties. The thickness of the space under vacuum is typically from 80 μm to 800 μm. In order to achieve a high insulation performance, the pressure inside the glazing unit is generally about 10⁻³ mbar or even lower. In order to obtain such a pressure inside the glazing unit, a seal is placed on the periphery of the two glass sheets and the vacuum is generated inside the glazing unit by virtue of a pump. In order to prevent the glazing unit from caving in under atmospheric pressure (due to the pressure difference between the interior and exterior of the glazing unit), spacers are placed regularly (for example in the form of a grid) between the two glass panels. Generally, at least one of the two glass sheets is covered with a low-E layer having an emissivity ideally lower than 0.05.

The spacers are generally cylindrical or spherical, the term “pillars” then being used. At the present time, these spacers are generally made of metal and therefore create thermal leaks in the glazing panel. In order to keep the thermal transmission coefficient U below 0.6 W/m²K, the total area of the spacers making contact with the glass must represent less than 1% of the area of the vacuum-insulated glazing panel.

Various seal technologies exist, each having certain drawbacks. A first type of seal (the most widespread) is a seal based on a solder glass the melting point of which is lower than that of the glass of the glass panels of the glazing unit. The use of this type of seal limits the choice of low-E layers to those that are not degraded by the thermal cycle required to implement the solder glass, i.e. to those that are able to withstand a temperature possibly as high as 350° C. In addition, since this type of solder-glass-based seal is only very slightly deformable, it does not allow the effects of differential expansion between the interior-side glass panel of the glazing unit and the exterior-side glass panel of the glazing unit when said panels are subjected to large temperature differences (for example 40° C.) to be absorbed. Quite substantial stresses are therefore generated at the periphery of the glazing unit and may lead to breakage of the glass panels of the glazing unit.

A second type of seal comprises a metal seal, for example a metal band of a small thickness (<500 μm) soldered to the periphery of the glazing unit by way of a tie underlayer covered at least partially with a layer of a solderable material of the soft tin-alloy solder type. One substantial advantage of this second type of seal relative to the first type of seal is that it is able to deform in order to absorb the differential expansion created between the two glass panels. There are various types of tie underlayers for glass panels.

U.S. Pat. No. 5,227,206 describes a first exemplary embodiment of a peripheral seal of the second type for a vacuum-insulated glazing unit. According to this embodiment, the seal is a metal band that has a substantially U-shaped cross section the two parallel flanges of which are connected to each other via a base that may be curved or straight. The two flanges sandwich the two glass sheets.

However, in the context of this first embodiment the band must be shaped into its final U-shape around the two glass panels. Specifically, it is not possible to place the two glass sheets and the spacers in a frame having a cross section that is an already closed U-shape. Thus, it is not possible to separate the step of manufacturing and fitting the seal band on the panel from that of assembly of the glass sheets of the glazing panel (thereby implying a longer assembly time and a higher cost).

Moreover, the metal band forms a thermal bridge on the periphery of the glazing unit between the exterior and interior of the glazing unit. This has the result of degrading the overall insulation performance of the glazing panel.

Moreover, in contrast to a “conventional” multiple glazing panel filled with gas or dry air, according to this solution the seal band is not protected by the two glass sheets, meaning that there is a risk that the seal will tear or perforate, possibly leading to leaks and possibly making it more difficult to install the glazing unit in its frame.

Patent No EP 2 099 997 B1 describes a second exemplary embodiment of a peripheral seal of the second type for a vacuum-insulated glazing unit. According to this embodiment, the seal also has a substantially U-shaped cross section the two parallel flanges of which are connected to each other via a base that may be curved or straight. The two glass sheets sandwich the two flanges.

Apart from the aforementioned drawbacks, in the context of this second embodiment it is necessary to implement an additional step of joining two bands.

Moreover, during assembly of a vacuum-insulated glazing panel, certain steps involve localized heating of the glass sheets, causing the size of one of the glass sheets to vary (by thermal expansion or contraction) relative to the other glass sheet. These variations in size may adversely affect the integrity of the peripheral seal and may sometimes lead the seal to detach from the panel.

### 3. OBJECTIVES OF THE INVENTION

An objective of the invention is in particular to overcome these disadvantages of the prior art.

More precisely, one objective of the invention, in at least one of its embodiments, is to provide a technique allowing a glazing panel comprising at least two glass sheets bounding at least one internal space to be sealably closed by virtue of a peripheral seal.

Another objective of the invention, in at least one of its embodiments, is to provide such a technique that allows the peripheral seal to be protected.

Another objective of the invention, in at least one of its embodiments, is to provide such a technique that allows the risk of the peripheral seal breaking or detaching from the panel in the case of thermal expansion or contraction of at least one portion of at least one of the glass sheets to be limited.

Another objective of the invention, in at least one of its embodiments, is to provide such a technique that allows the effectiveness of a degassing operation implemented in the internal space to be improved.

Another objective of the invention, in at least one of its embodiments, is to provide such a technique allowing the glazing panel to be mounted in a conventional multiple glazing unit frame.

Another objective of the invention, in at least one of its embodiments, is to provide such a technique that is easy to implement.

Yet another objective of the invention, in at least one of its embodiments, is to provide such a technique that is inexpensive.

### 4. SUMMARY OF THE INVENTION

According to one particular embodiment, the invention relates to a peripheral seal for a glazing panel, in particular an insulating glazing panel, comprising at least first and second glass sheets associated together by way of at least one spacer that holds them a certain distance from each other and, between said at least two glass sheets, at least one internal space is closed by the peripheral seal placed on the periphery of the glass sheets, around said internal space.

According to the invention, the cross section of the seal comprises a median portion and first and second end portions securely fastened to the first and second glass sheets, respectively.

According to the invention, the cross section of the seal forms at least one cavity facing at least one of the edge faces of the first and second glass sheets.

Of course, the roles of the first and second glass sheets are interchangeable.

Of course, the term “glass” is understood to mean any type of glass or equivalent transparent material, such as a mineral glass or an organic glass. The mineral glass used may be irrespectively one or more known types of glass such as soda-lime glass, borate glass and crystalline and semicrystalline glass. The organic glass used may be a rigid thermoplastic or thermosetting transparent polymer or copolymer such as, for example, a transparent synthetic polycarbonate, polyester or polyvinyl resin.

The general principle of the invention is based on producing at least one cavity facing at least one of the edge faces of the first and second glass sheets.

Thus, the technique for securely fastening the peripheral seal to the panel according to the invention increases the protection of the peripheral seal and in particular this technique allows the risk of the peripheral seal braking or detaching from the panel in the case of thermal expansion or contraction of at least one portion of at least one of the glass sheets to be limited.

Furthermore, the seal may be protected by a polymer bead (bead of silicone, PU, etc.) in the same way as in conventional multiple glazing units. Thus, such a technique allows the glazing panel to be mounted in a conventional multiple glazing unit frame.

Moreover, this technique for securely fastening the seal allows the thermal insulation performance of the glazing panel to be improved especially because losses due to edge effects are decreased.

Preferably, the seal furthermore comprises elastic means for obturating said cavity in at least one portion of the peripheral seal.

During the process of assembly of the panel, in order to clean the faces internal to the panel of the first and second glass sheets, for example, in order to obtain a purer insulating gas in the internal space of a double glazing unit or in order to improve the vacuum performance of a vacuum-insulated glazing panel, it is possible to implement a degassing step or even a step in which a cleaning liquid, such as an aqueous solution containing a basic detergent, such as RBS50 for example, or even an isopropyl alcohol, having a low evaporation point easily reachable by heating the glazing unit in an oven, for example, is made to flow through the unit.

The expression “face external to the panel of a glass sheet” is understood to mean the face that does not adjoin the internal space. Likewise, the expression “face internal to the panel of a glass sheet” is understood to mean the other face (i.e. the face that does not adjoin the external space).

Such as illustrated by FIG. 2, the degassing step is for example carried out by flowing an oxidizing gas such as nitrous oxide (N₂O), water vapor, air or ozone (O₃) 12 between the first and second glass sheets 5 of the glazing panel. Preferably, the degassing is carried out once the panel has been sealably closed by virtue of the peripheral seal 1. Preferably, the flow of oxidizing gas enters into the internal space of the panel via an inlet tube 11 and exits from the internal space via an outlet tube 13, said tubes for example being securely fastened to first and second apertures provided in the seal, respectively.

However, the cavity facing at least one of the edge faces of the first and second glass sheets, which cavity is formed by the cross section of the seal, makes it possible for at least part of the flow of oxidizing gas, gas such as nitrous oxide (N₂O), water vapor, air or ozone (O₃) 12, or part of the liquid cleaning flow, to leak out of the panel, which part therefore does not pass through the internal space of the panel, thereby decreasing the effectiveness of the degassing or the step of cleaning with a flow of cleaning liquid.

Thus, employing elastic means for obturating this cavity allows the effectiveness of a degassing operation or of the step of cleaning with a flow of cleaning liquid to be improved. Furthermore, because they are elastic, the obturating means allow the cavity to preserve its function of absorbing any thermal expansion or contraction of at least one portion of at least one of the glass sheets. Specifically, if a glass sheet sees its size, in the plane of the panel, increase by thermal expansion, then this glass sheet pushes on the elastic obturating means that then deform so as to accommodate the increase in the size of the glass sheet.

Advantageously, the elastic obturating means comprise at least one strip portion forming a spring of the same height as the height of said cavity.

Advantageously, the strip portion is made of copper.

Advantageously, a plurality of strip portions are positioned at regular intervals along sides parallel to the gas flow. For example, the first strip portion may be placed in proximity to the corner then the following strip portions may be placed a distance of between 50 and 100 mm from each other.

According to one advantageous feature of the invention, the elastic obturating means are produced by preforming the median portion of the cross section of the seal.

Advantageously, the seal has an S-shaped cross section comprising a first flange securely fastened to the first glass sheet and a second flange securely fastened to the second glass sheet.

Advantageously, the seal has a U-shaped cross section comprising a first flange securely fastened to the first glass sheet and a second flange securely fastened to the second glass sheet.

According to one advantageous feature of the invention, the pressure in the internal space is lower than 1 mbar.

Thus, the glazing panel is a vacuum-insulated glazing panel.

Advantageously, the spacers are placed between the first and second glass sheets so as to form a grid the pitch of which is comprised between 20 mm and 80 mm and preferably comprised between 30 and 60 mm.

Advantageously, the glazing panel furthermore comprises a thermally insulating layer placed on an internal surface of at least one of the glass sheets.

Thus, the overall thermal insulation obtained by virtue of the glazing panel is further improved.

Advantageously, the peripheral seal is a metal seal.

According to one advantageous feature of the invention, the peripheral seal is a metal band.

Advantageously, at least one flange of the seal is securely fastened to the corresponding glass sheet by soldering at least one portion of the flange to an adhesion layer provided on the portion of the glass sheet receiving the portion of the flange.

The invention also relates to a glazing panel, in particular an insulating glazing panel, comprising at least first and second glass sheets associated together by way of at least one spacer that holds them a certain distance from each other and, between said at least two glass sheets, at least one internal space.

According to the invention, the internal space is closed by a peripheral seal such as described above, said seal being placed on the periphery of the glass sheets, around said internal space.

### 5. LIST OF FIGURES

Other features and advantages of the invention will become more clearly apparent on reading the following description of one preferred embodiment, given by way of simple illustrative and nonlimiting example, and from the appended drawings, in which:

FIG. 1 shows a schematic of a vacuum-insulated glazing panel according to one embodiment of the invention;

FIG. 2 illustrates one implementation of a step of degassing the internal space of the glazing panel in FIG. 1; and

FIGS. 3a and 3b show first and second peripheral seals of the panel in FIG. 1, according to first and second embodiments of the invention, respectively.

### 6. DESCRIPTION OF ONE EMBODIMENT OF THE INVENTION

The present invention will be described with reference to particular embodiments and with reference to certain drawings; however, the invention is not limited thereby and is limited only by the claims. In the drawings, the size and relative dimensions of certain elements may have been exaggerated and not drawn to scale for the sake of illustration.

In addition, the terms “first”, “second”, “third” and similar terms in the description and in the claims are used to distinguish between similar elements and not necessarily to describe a sequence whether it be temporal, spatial, for the sake of classification or otherwise. Of course, the terms thus used are interchangeable in appropriate circumstances and of course the embodiments of the invention described here are capable of being used in other sequences than those described or illustrated here.

In addition, the terms “high”, “low”, “above”, “below” and similar terms in the description and claims are used for descriptive purposes and not necessarily to describe relative positions. Of course, the terms thus used are interchangeable in appropriate circumstances and of course the embodiments of the invention described here are capable of being used in other orientations than those described or illustrated here.

It will be noted that the term “comprising”, used in the claims, must not be interpreted as being restricted to the means listed thereafter; it does not exclude other elements or steps. It must therefore be interpreted as specifying the presence of the specified elements, units, steps or components referenced, but not excluding the presence or addition of an element, unit, step or component, or group thereof. Therefore the scope of the expression “an apparatus comprising the means A and B” must not be limited to apparatuses consisting only of components A and B. In other words, as regards the present invention, the only relevant components of the apparatus are the components A and B.

Such as used here and unless otherwise indicated, the expression “seal-tight” is understood to mean seal-tight to any gas that could be used in a double glazing unit to improve insulation (argon for example) or seal-tight to air or any other gas present in the atmosphere (in the case of a vacuum-insulated glazing unit).

Such as used here and unless otherwise indicated, the expression “thermally insulating layer” is understood to mean a layer of metal oxide having an emissivity lower than 0.2, preferably lower than 0.1 and more preferably lower than 0.05. A thermally insulating layer may for example be one of the following layers: Planibel G, Planibel Top N, Top N+ and Top 1.0 sold by AGC.

Such as used here and unless otherwise indicated, the term “spacer” relates to one or more elements ensuring a relatively constant distance is maintained between two adjacent glass panels.

Below, the particular case where a glazing panel according to the invention is a vacuum-insulated glazing panel is considered. Of course, the invention also applies to any type of glazing panel comprising glass sheets (two, three or more) bounding insulating or non-insulating internal spaces (also called multiple glazing panels).

For example, the invention also applies to a double glazing panel the internal space of which may enclose a gas, for example, but not exclusively, dry air, argon (Ar), krypton (Kr), xenon (Xe), sulfur hexafluoride (SF₆) or even a mixture of certain of these gases.

Again for example, the invention also applies to a triple glazing panel comprising a first internal space in which a vacuum is produced and a second internal space enclosing one or more insulating gases.

Of course, other variants are envisionable and in particular one of the glass sheets of the panel may be replaced by a laminated glass panel and any other addition or modification may be made.

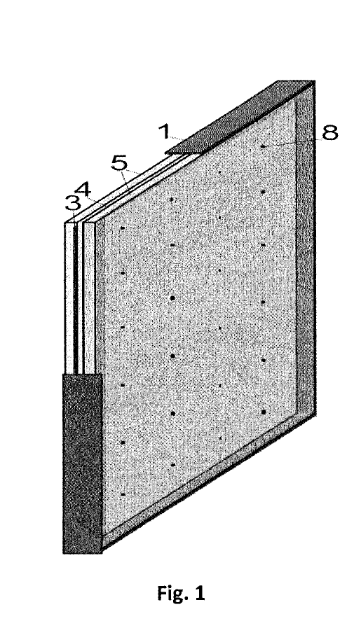

FIG. 1 shows a view of an entire vacuum-insulated glazing panel according to one embodiment of the invention.

The vacuum-insulated glazing panel comprises first and second glass sheets 5 (for example 6 mm-thick clear soda-lime-silica glass sheets) that are associated together by way of at least one spacer 8 that keeps them a certain distance apart. Thus, the first and second glass sheets 5 are separated by a first internal space 4 forming a first cavity in which the pressure is lower than 1 mbar and for example equal to 10⁻³ mbar (obtained by pumping out the cavity using a vacuum pump).

Of course, any other type of glass and thickness of glass may be employed.

The vacuum-insulated glazing panel also comprises a plurality of spacers 8 according to the invention, the spacers being sandwiched between the first and second glass sheets 5 so as to maintain the first space between these glass sheets 5.

For example, the spacers are placed between the first and second glass sheets so as to form a grid the pitch of which is comprised between 20 and 80 mm and preferably comprised between 30 and 60 mm.

The spacers 8 may be different shapes, such as cylindrical, spherical, filiform, hour-glass shaped, cruciform, etc.

Below, an example according to the invention in which the spacers 8 are made of AISI301 steel and have a C shape is considered.

The step of forming the austenitic steel first comprises a step of obtaining a wire of cylindrical cross section by drawing. Of course, the step of obtaining the wire may also be obtained by hot extrusion of said AISI301 steel then drawing, allowing the final diameter of the wire to be achieved.

For example, starting with a wire of 5 mm diameter that is then drawn, a thin wire having a diameter of 1 mm (which represents a reduction in the cross section of the wire of 80%) is obtained.

The step of forming the austenitic steel then comprises a step of cutting (for example by means of a wire cutter) at least one portion of the wire in order to form said spacer. For example, the length of said wire portion is 4 mm.

According to one advantageous embodiment, the step of forming the austenitic steel then comprises a step of bending at least one portion of said wire portion so as to form a loop portion the maximum radius of curvature of which is 0.5 mm.

Of course, the bending step may be carried out before the cutting step.

Preferably, the wire portion is a circular portion the radius of curvature of which is 0.5 mm.

Thus, in the context of this second example, the work-hardening step is merged with the drawing step.

Thus, during the drawing operation, the cross section of the wire is decreased by 80% and the strength of the AISI stainless steel is thereby increased from 620 MPa to about 1400 MPa.

For example, if spacers made of non-work-hardened AISI (which therefore have a compressive strength of 620 MPa) that have a contact area equivalent to a disk of 250 μm radius are used, spaced apart from one another by 30 mm, the value of the U coefficient of the vacuum-insulating glazing panel obtained is equal to 0.8 W/m²K.

In contrast, using the aforementioned spacers according to the invention (made of work-hardened AISI 301 and shaped into a C) having a compressive strength of 1400 MPa, the number of spacers may be decreased by separating them by 50 mm while simultaneously improving the U value which is then about 0.5 W/m²K.

U values are estimated for the vacuum-insulated glazing units based on a glazing unit such as described above, comprising a low-E layer. The thermal transmissions (U values) were evaluated using the method described in the publication of the University of Sydney: DETERMINATION OF THE OVERALL HEAT TRANSMISSION COEFFICIENT (U-VALUE) OF VACUUM GLAZING, T M. Simko, A H. Elmandy and R E. Collins. ASHRAE Transactions, 105, pt 2, p. 1-9. 1999.

In order to further improve performance in terms of thermal insulation, a thermally insulating layer may be placed on an internal surface of at least one of the glass sheets 5.

The two glass sheets 5 are assembled and made gas-tight (ensuring the vacuum) via a peripheral seal 1 placed on the periphery of the glass sheets 5 around the internal space 4, shutting the first cavity.

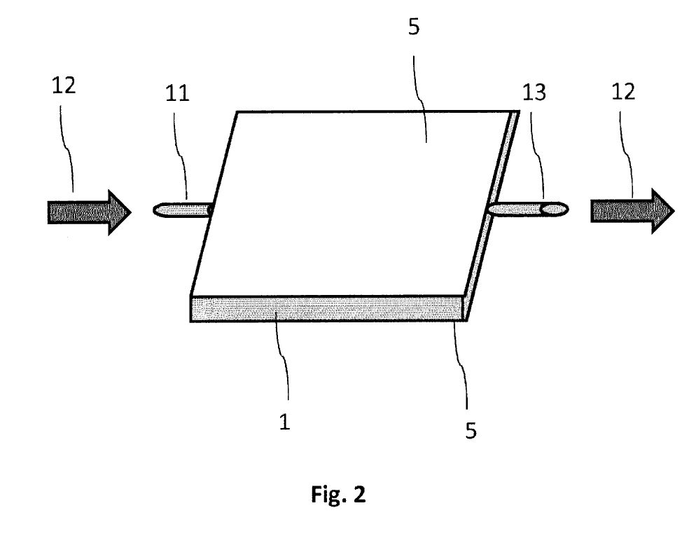

Such as indicated above, FIG. 2 illustrates the implementation of a step of degassing the internal space 4 of the glazing panel. Of course, although the panel in FIG. 1 is a vacuum-insulated glazing panel, the degassing step in FIG. 2 could be implemented in any other type of glazing panel according to the invention.

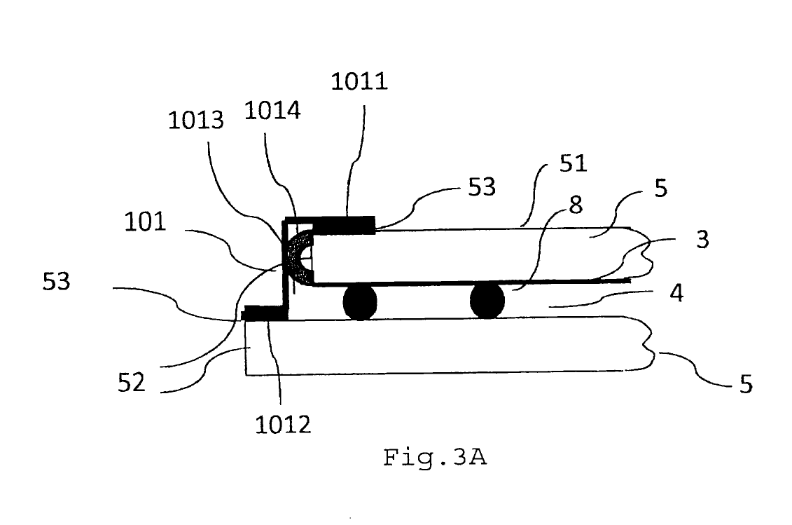

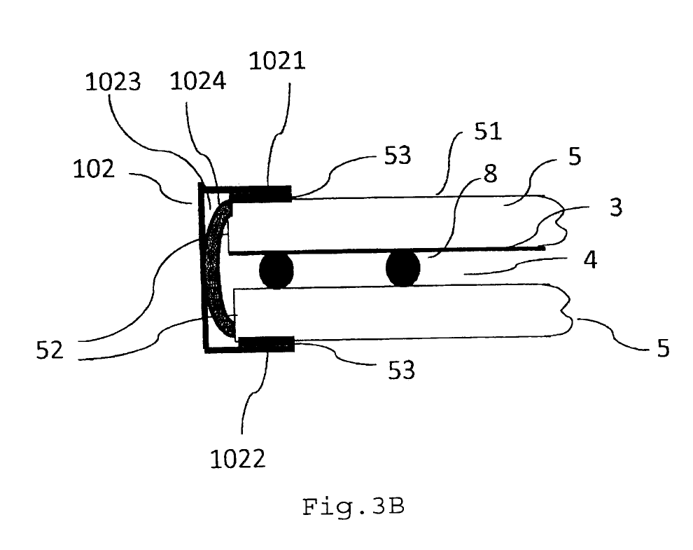

FIGS. 3a and 3b show first 101 and second 102 peripheral seals of the panel in FIG. 1, according to first and second embodiments of the invention, respectively.

FIGS. 3a and 3b show only portions of the cross section of the glazing unit.

For each of the first 101 and second 102 peripheral seals, the cross section of the seal comprises a median portion and first 1011; 1021 and second 1012; 1022 end portions securely fastened to the first and second glass sheets 5, respectively.

For each of the first 101 and second 102 peripheral seals, the cross sections of the first 101 and second 102 peripheral seals form first 1013 and second 1023 cavities, respectively, facing the edge face 52 of the first glass sheet 5 and the edge faces 52 of the first and second glass sheets 5, respectively.

The first 101 and second 102 seals furthermore comprise first 1014 and second 1024 elastic means for obturating the first 1013 and second 1023 cavities over at least one portion of the peripheral seal 101; 102, respectively.

For example, the elastic obturating means comprise at least one strip portion forming a spring 1014; 1024, for example made of copper, which strip portion is integrated into the cavity.

By way of alternative (not illustrated), the elastic obturating means 1014; 1024 may be produced by preforming the median portion of the cross section of the seal 101, 102.

Again by way of alternative (not illustrated), the elastic obturating means 1014; 1024 may be produced using a material of mineral chemical composition that is elastically deformable so as to be able to absorb any contraction and expansion of one or both glass sheets. The obturating means may for example consist of a braid of mineral fibers the diameter of which is such that it partially or completely fills the cross section of the cavity. One way of carrying out the invention is to obturate the cavity over its entire length. Another way of carrying out the invention is to obturate the cavity over a portion of its length. The material used will preferably be a mineral material, such as a ceramic, glass or metal. One way of carrying out the invention is to use twisted refractory aluminosilicate fibers (SiO₂: 56%; Al₂O₃: 32%; Na₂O: 3.5%; CaO: 3%; MgO: 1%; TiO₂; 0.7%) the diameter of which is comprised between 15 and 20 μm.

The first seal 101 has an S-shaped cross section comprising a first flange 1011 securely fastened to the first glass sheet and a second flange 1012 securely fastened to the second glass sheet.

The second seal 102 has a U-shaped cross section comprising a first flange 1021 securely fastened to the first glass sheet and a second flange 1022 securely fastened to the second glass sheet.

Furthermore, the seals may be protected by a polymer (silicone, PU, etc.) bead (not illustrated) in the same way as in conventional multiple glazing units.

The first 101 and second 102 peripheral seals are for example metal bands each having a U-shaped cross section and each comprising first and second flanges.

The first 1011; 1021 and second 1012; 1022 flanges of the first 101 and second 102 seals are securely fastened to the first and second glass sheets 5, respectively, by soldering (for example carried out using a tin solder) a portion of these flanges to portions of adhesion layers 53 provided on the periphery of the corresponding glass sheets.

For example, the adhesion material forming the adhesion layers 53 may be selected from the group composed of copper and its alloys (for example with titanium and/or chromium), aluminum and its alloys, iron and its alloys (such as austenitic Fe—Ni steels: e.g. iron (50-55% by weight, for example 52% by weight), nickel (45-50% by weight, for example 48% by weight), such as alloy 48), the iron alloys comprising the following metals: iron (53-55% by weight, for example 53.5% by weight), nickel (28-30% by weight, for example 29% by weight) and cobalt (16-18% by weight, for example 17% by weight), and Kovar®, platinum and its alloys, nickel and its alloys, gold and its alloys, silver and its alloys, gallium arsenide and tin or its alloys. This list not being exhaustive.

Of course, the seal may be obtained in any other way, for example by virtue of two metal bands soldered in voids of the glass sheets and also soldered together. Moreover, any other technique for securely fastening the seal to the void(s) may be used without departing from the scope of the invention, for example a weld obtained by directly welding glass to glass (no adhesion layer 53 is required in this case) or by force fitting.

Of course, according to variants (not illustrated) of the aforementioned embodiment, the glazing panel may furthermore comprise a third glass sheet separated from either one of the first and second glass sheets (for example from the second glass sheet) by a second space in order to form a second cavity.

According to a first variant, a second seal is furthermore placed on the periphery of the third and second glass sheets in order to maintain the second (16-mm thick, for example) space, said second cavity being filled with at least one gas. The gas may for example be air, argon, nitrogen, krypton, xenon, SF₆, CO₂, or any other thermally insulating gas.

According to a second variant, the third and second glass sheets are assembled and made gas-tight (ensuring the vacuum) via a seal placed on the periphery of the glass sheets, shutting the second cavity, and a plurality of spacers according to the invention are sandwiched between the third and second glass sheets so as to maintain the second space between these glass sheets. Thus a vacuum-insulated triple glazing unit is obtained.

Of course, other variants are envisionable and in particular a glass sheet may be replaced by a laminated glass panel and any other addition or modification may be made.

Of course, the invention is not limited to the abovementioned exemplary embodiments.

1. A peripheral seal, comprising at least first and second glass sheets associated together by way of a spacer that holds them a certain distance from each other, wherein between the at least two glass sheets, an internal space is closed by the peripheral seal placed on the periphery of the glass sheets, around the internal space,
the cross section of the seal comprising a median portion and first and second end portions securely fastened to the first and second glass sheets, respectively;
wherein the cross section of the seal forms a cavity facing an edge face of the first and second glass sheets.

2. The seal as claimed in claim 1, wherein the seal further comprises an elastic means configured for obturating the cavity in at least a portion of the peripheral seal.

3. The seal as claimed in claim 2, wherein the elastic obturating means comprises a strip portion forming a spring.

4. The seal as claimed in claim 3, wherein the strip portion is made of copper.

5. The seal as claimed in claim 2, wherein the elastic obturating means comprises an assembly of mineral fibers.

6. The seal as claimed in claim 2, wherein the elastic obturating means is produced by preforming the median portion of the cross section of the seal.

7. The seal as claimed in claim 1, wherein the seal has an S-shaped cross section comprising a first flange securely fastened to the first glass sheet and a second flange securely fastened to the second glass sheet.

8. The seal as claimed in claim 1, wherein the seal has a U-shaped cross section comprising a first flange securely fastened to the first glass sheet and a second flange securely fastened to the second glass sheet.

9. The seal as claimed in claim 1, wherein a pressure in the internal space is lower than 1 mbar.

10. The seal as claimed in claim 1, wherein the peripheral seal is a metal seal.

11. The seal as claimed in claim 1, wherein the peripheral seal is a metal band.

12. The seal as claimed in claim 10, wherein a flange of the seal is securely fastened to the corresponding glass sheet by soldering at least a portion of the flange to an adhesion layer on the portion of the glass sheet receiving the portion of the flange.

13. A glazing panel, comprising at least first and second glass sheets associated together by way of a spacer that holds them a certain distance from each other and, between the at least two glass sheets, an internal space, wherein the internal space is closed by a peripheral seal as claimed in claim 1, the seal being placed on the periphery of the glass sheets, around the internal space.
